(19) United States
(12) Patent Application Publication
(10) Pub. No.: US 2006/0179675 A1
(43) Pub. Date: Aug. 17, 2006

(54) Device for labeling circular data carrier, especially compact discs

(76) Inventor: Stephan Ducret, Mohlen (CH)

Correspondence Address: SHOEMAKER AND MATTARE, LTD, 10 POST OFFICE ROAD - SUITE 110, SILVER SPRING, MD, 20910, US

(21) Appl. No.: 10/552,148

(22) PCT Filed: Mar. 8, 2004
(86) PCT No.: PCT/EP04/02334

§ 371 Date: Mar. 10, 2006

(30) Foreign Application Priority Data
Apr. 8, 2003 (CH) 064/03

(51) Int. Cl. B43L 13/20

(52) U.S. Cl. 33/564

(57) ABSTRACT

The invention provides a writing and drawing stencil which comprises a support disc carrying characters (4), numbers or symbols that are concentrically arranged and configured as open-work The stencil is provided with means for retaining (7; 12) or guiding a compact disc (6) that allow the compact disc (6) to be rotated support disc relative to the compact disc (6).

The invention relates to a device for labeling circular data carriers, especially compact discs.

The known writable circular data carriers, such as compact discs (CD-R) or digital versatile discs (DVD) for example, have the data carrier coating on one side and the second side serves for the inscription of the data carrier. These data carriers are commercially available as so-called blanks, on which data can be stored by using a CD burner. As soon as a blank has been burned, it is usually provided with an inscription or marking, which indicates the stored content of the data carrier.

A very popular method of labeling burned discs is the adhesive attachment of a printed, circular, usually self-adhesive film to the upper side of the disc. For this purpose, a layout, which may comprise graphics and script, is designed with the aid of a special computer program, and subsequently the film is printed with it. These films or labels are arranged on a backing film and pre-punched. After the detachment of a printed, circular self-adhesive label, the latter must be adhesively applied concentrically to the disc. Though the adhesive attachment of such films to the discs is an ideal solution visually, it presents some problems in practice. Although there are means to assist adhesive attachment, it requires some dexterity to attach the film to the data carrier exactly centrally and without any bubbles. Films that are attached off-center may lead to out-of-round running of the CD at high rotational speed as a result of the effect of centrifugal force, which puts an unnecessary load on the drive. In addition to this there are repeated instances of the film becoming detached, which may be disastrous if it happens in the drive itself.

The simplest case of labeling a CD is freehand inscription with a water-resistant writing implement. Though the described disadvantages of adhesively attaching a label to a disc are avoided with this type of inscription, it does not in any way meet demanding esthetic requirements.

A further method of inscription of CDs is that of printing directly on the discs. However, the equipment necessary for this is expensive and therefore does not come into consideration for the final consumer.

It is therefore an object of the invention to provide a device of the type mentioned at the beginning which is as simple as possible in its handling, which can be produced at low cost and with which esthetically satisfactory inscriptions or other labelings of the data carriers are possible.

This object is achieved according to the invention by a device which has the features in claim 1. The mounting means for the rotationally movable relative displacement between the stencil and the data carrier about the center of the data carrier ensure that the characters are arranged in arcuate rows. The device according to the invention is suitable not only for labeling compact discs or mini discs as digital data carriers, but in certain cases also for labeling analog vinyl gramophone records.

The device is particularly advantageously suitable for labeling data carriers with a central opening if the stencil has a mounting opening of a diameter made to match the diameter of the central opening on the data carrier in such a way that the stencil can be placed rotatably onto a mount penetrating through the central opening. CDs are normally kept in a CD case, which is provided with a flexible mount for the relatively rotationally secure fixing of the CD at the central opening. The stencil can in this way be placed onto the CD mount while the CD case is open, the stencil being guided and centered at the mounting opening.

The stencil is in this case advantageously likewise formed as a circular disk, its outside diameter being at least approximately the same size or greater than that of the data carrier and the mounting opening being arranged in the center. The stencil itself in this case resembles a commercially available compact disc in shape and appearance and can be stored like it in a cassette. However, it would also be quite conceivable for the stencil to have a different outer configuration, it also being possible if appropriate for the outer edge to serve as a stencil for linear guidance.

The stencil is preferably provided on its side facing the data carrier with spacing elements, in order to avoid underflowing and smearing of inscription fluid. The spacing elements preferably have the form of an inner spacing ring, surrounding the mounting opening, and an outer spacing ring, surrounding the labels. In this way, the spacing elements cannot cause smearing of the inscription already performed even when there is relative rotation.

The device may have a carrier element with a mount penetrating through the central opening of the data carrier, it being possible for the data carrier to be connected in a rotationally secure manner to the carrier element at least when the stencil is in place. The rotationally secure connection could be achieved for example by a slight press fit between the mount and the central opening. In certain cases, however, it is sufficient for the surface friction between the carrier element and the data carrier to be set in such a way that, when the stencil is in place, only the stencil can rotate in relation to the data carrier.

The device may also have, however, a storage case with two wall portions arranged at a distance from each other and with mounting means for the rotatable mounting of the data carrier between the wall portions, one of the wall portions having the stencil. A storage case of this type may be formed, for example, like a conventional CD case in which the CD to be inscribed is placed. The cover of the CD case is formed as a stencil, so that, when the cover is closed, an inscription of the CD is possible.

In such a case, the data carrier is rotated in relation to the stencil, which is possible as a result of corresponding lateral clearances in the storage case.

The storage case may, however, also be formed as an insert case with a lateral insert opening for the data carrier, the stencil being arranged on a side wall of the insert case. In the case of the insert case, the means for the rotationally movable mounting of the data carrier act on the outer circumference and not in the center of the data carrier.

The stencil is preferably produced from a transparent or partly transparent material, in particular from a plastics material. As a result, the stencil can be produced in a particularly simple way in an injection mold. As a consequence of the transparent formation, the label last written in each case is visible, which makes a regular arrangement of the characters in rows possible. The setting of the characters may also be facilitated by markings permitting the maintenance of equal intervals between the characters being arranged on the stencil between or over the character apertures.

The labels on the stencil are arranged on preferably a number of circular rings, which run concentrically in relation to the axis of rotation. This allows a number of circular ring-like and concentric lines to be inscribed. The inscription may take place through the apertures, for example with a conventional felt pen or with some other suitable writing implement.

Further advantages and individual features of the invention emerge from the following description of exemplary embodiments and from the drawings, in which:

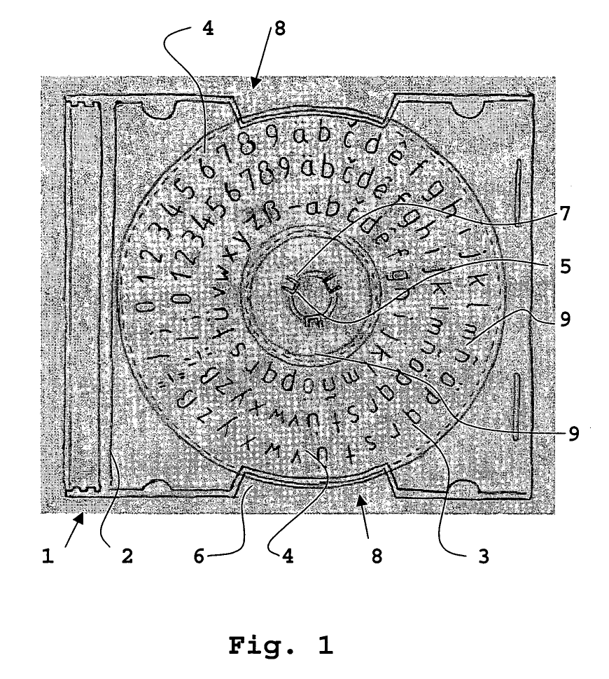

FIG. 1 shows a CD case with a hinged cover, seen from above, in which the cover forms the writing and drawing stencil with concentrically arranged characters,

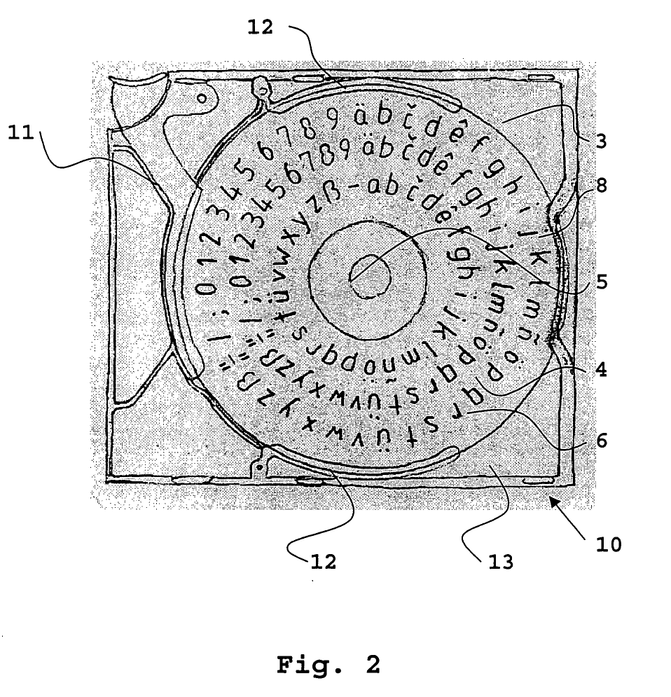

FIG. 2 shows a CD insert case, seen from above, in which the upper side of the case forms the writing and drawing stencil with concentrically arranged characters,

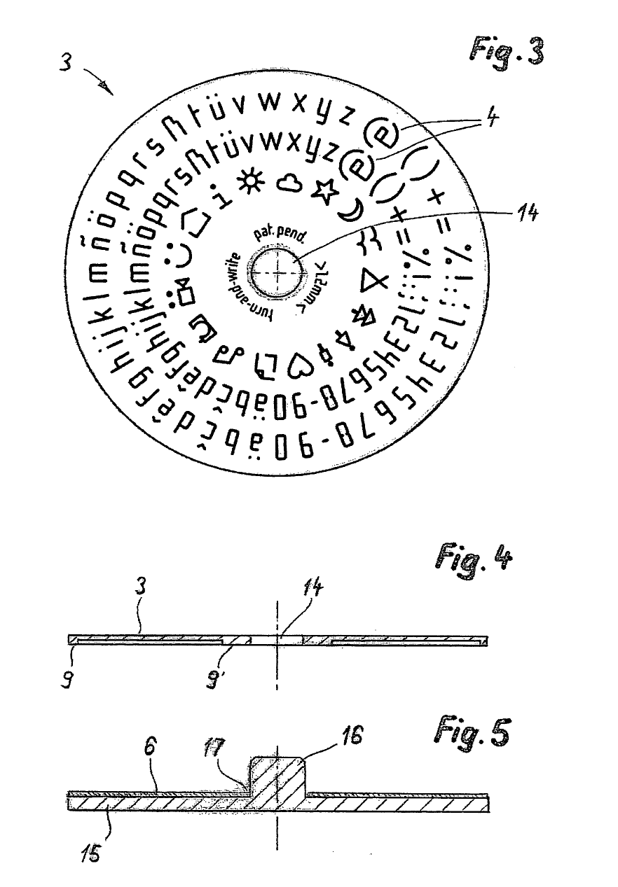

FIG. 3 shows a plan view of a circular disk-shaped stencil with a central mounting opening,

FIG. 4 shows a cross section through the stencil according to FIG. 3, and

FIG. 5 shows a cross section through a carrier disk with a compact disc placed on it.

Linear writing stencils, as are used for example for providing inscriptions on technical drawings, are sufficiently known. They comprise a carrier plate with letters and characters arranged next to one another in a row and made as apertures in the form of openwork. The principle of the invention is therefore that, on a writing and drawing stencil, the letters and characters are arranged concentrically around a center point. The stencil also has a mount or guide, which allows a disk-shaped data carrier to be rotatably held or guided, so that the data carrier and the stencil are rotatable with respect to each other about the center point or the point of rotation. The mount or the stencil guide may be arranged either in the center of the CD or at the outer circumference of the CD and the CD may be rotatable with respect to the stencil, or the stencil may be rotatable with respect to the CD, about their common point of rotation.

To inscribe a disc, the stencil is placed onto the CD to be provided with the inscription, so that the center of the concentrically arranged letters and characters comes to lie superjacent with the center point of the CD. If, for example, the word SONG is to be written onto the CD, first the letter S is traced with an appropriate pen by means of a corresponding clearance in the stencil. After that, the stencil or the CD is turned about a center point with respect to the other, so that the clearance for the following letter O comes to lie after the letter S and can be written with the pen. In this way, the word is completed, so that it comes to lie concentrically on the CD. If further words or characters are also to be written, this can take place after the word already written, or else concentrically under the word that has been written, since the letters and characters are arranged on the stencil in a number of concentric rows. On its side facing the CD, the stencil has lands or small protuberances, in order that the stencil does not rest on the CD. This prevents the written and not yet dried letters from being smeared during rotation.

In principle, the use of the stencil according to the invention in the way described above can be realized with a customary CD case. The stencil thereby has the form of a conventional CD. The CD to be provided with an inscription is made to engage in the CD case in such a way that it is fitted as securely as possible and does not rotate. The template is placed congruently over it. The stencil has a hole in the center, the diameter of which corresponds to the diameter of the cylindrical CD mount in the CD case. The CD mount in this case also serves as a mount or guide for the stencil, about which the stencil is rotatable. The lands or protuberances by which the stencil rests on the CD keep the CD at a distance from the stencil and in this way prevent smearing of the already written letters during rotation of the CD. Different forms of script, symbols, figures and characters and different sizes of script, symbols and characters may be arranged on different stencils. The stencils can easily be exchanged or changed for one another. In this way, the user has great artistic freedom for the inscription and labeling of the data carrier.

FIG. 1 shows an embodiment of the stencil according to the invention, in which the transparent, hinged cover 2 of a CD case 1 serves as a stencil 3. The characters 4, letters 4 or numbers 4 are arranged in concentric rows, the center point 5 of the concentric rows coming to lie over the center point of the cylindrical CD mount 7 for the CD 6 when the cover is closed. These center points consequently also correspond to the axis of rotation about which the relative rotation takes place. Clearances 8 at the edge of the cover 2 of the CD case 1 make it possible for the CD 6 to be turned to the desired letter. In this case, the CD 6 is therefore rotated with respect to the stencil 3. In the illustration, two clearances 8 are provided on opposite sides of the cover 2. Only one or a number of clearances 8, possibly also arranged at the corners of the CD case 1, are also conceivable, allowing the rotation of the CD 6 when the cover 2 is closed. Advantageously arranged on the inner side of the cover, either near the center or between the letters (not shown here) or in the outer region of the rows of characters are protuberances or supporting ribs 9, which keep the CD 6 at a distance from the stencil 3, in order to prevent smearing of the written letters during rotation of the CD 6. To maintain equal intervals between the characters to be written, corresponding markings may be provided on the stencil 3. For example, short radially extending lines or windows in the form of notches or imprints are helpful. When writing a letter, the window arranged on the stencil to the left of the letter that is to be written is pushed over the letter that has already been written. In this way, the interval with respect to the letter that is to be written is clearly defined. The principle therefore works on the basis that in each case the character that is last written comes to lie in the window before the character that is newly to be written. In this way, letter can be written against letter and number against number while maintaining a consistently equal interval. Instead of the window, a simple marking may be set in this stencil as a spacing aid before each character in the form of a letter or number. The marking is in this case placed at the end of the character last written.

In FIG. 2, a CD insert case 10 is shown, seen from above. In this embodiment, the upper transparent side 13 of the case forms the carrier disk of a writing and drawing stencil 3 with letters 4, numbers or characters arranged concentrically and made as apertures in the form of openwork. Arranged inside this case 10, on the transverse side opposite from the opening, is a pivoting arm 11. This pivoting arm serves for ejecting a CD 6 pushed into the case 1. With two arcuate holding elements 12 arranged on the longitudinal sides, part of the pivoting arm 11 forms the mount and guide of a CD 6 placed into the CD case 10. The arcuate holding elements 12 consist of an elastic material with a U-shaped cross-sectional profile. A CD pushed into the CD case 10 is received by the holding elements 12 and rotatably held in the edge region of the CD 6, the U profile of the holding elements 12 having the effect that the CD 6 has no contact with the inner surfaces of the case. The center point 5 about which the characters 4 are concentrically arranged on the upper side 13 of the CD insert case 10 lies exactly above the center point of a CD pushed into the CD insert case. The CD case 1 has a clearance 8 in the edge region, so that a CD 6 pushed into the CD case 1 is rotatable. In the example shown, the clearance 8 is located on the upper side 13 of the case. As a result, the underside of the CD, that is to say the data carrier layer, is covered and protected by the underside of the case. It goes without saying that the clearance 8 may be formed by a shaped formation of the upper side and underside of the case 1. This has the advantage that the disc 6 can easily rotate during the inscription. To provide the disc 6 with an inscription, the same procedure is followed as when providing an inscription with the CD case 1 with a hinged cover 2. Since the disc surface to be inscribed does not have any contact with the CD case, the written characters are also not smeared when the CD is rotated during the inscription.

In the exemplary embodiment according to FIGS. 3 and 4, the device exclusively comprises a circular disk-shaped stencil 3 of transparent plastics material on which the apertures with the labels 4 are arranged on three concentric circular rings. The stencil has an outside diameter of 120 mm, which corresponds approximately to the outside diameter of a commercially available compact disc. Arranged in the center is a mounting opening 14 with an inside diameter of 15 mm, which likewise corresponds approximately to the inside diameter of a central opening 17 (FIG. 5) on a commercially available compact disc 6. As can be seen from FIG. 4, the stencil 3 has on its side facing the data carrier, at the outer circumference, a ring-shaped spacing element 9. Also arranged directly around the mounting opening 14 is a ring-shaped spacing element 9′. In this way, the character apertures are always arranged at a distance from a compact disc lying thereunder.

The stencil according to FIG. 3 may be placed directly onto a compact disc, which is arranged in a conventional CD cassette case with the cover open. As an additional means of assistance, however, a carrier disk according to FIG. 5, which has a mounting pin 16 in the center, may also be used. The data carrier 6 is pushed with its central opening 17 over the mounting pin 16, the tolerances being dimensioned such that a slight press fit is achieved. The data carrier is in this case held on the carrier disk relatively securely in terms of rotation. A stencil according to FIGS. 3 and 4 is then placed onto the data carrier or onto the carrier disk in such a way that the mounting pin 16 penetrates through the mounting opening 14 of the stencil. The tolerances are chosen in relation to the mounting opening 14 such that sliding mounting with the least possible play is possible. The stencil can now be turned into any desired angular positions to apply the characters.

The embodiments described are only given by way of example for the stencil according to the invention. The advantage of the embodiments mentioned is that they can be produced at low cost and are easy to use. The blanks are indeed usually offered in multipacks. It is conceivable to include a corresponding stencil in a multipack. The pack may also be accompanied by a suitable writing pen.

1. A device for labeling circular data carriers, especially compact discs, characterized by a stencil, on which labels are arranged as apertures, means for the rotationally movable mounting of the stencil and/or the data carrier about an axis of rotation being present in such a way that the stencil lies plane-parallel over the data carrier and that, for sequentially applying the labels, the stencil and the data carrier are rotatable in relation to each other about the center of the data carrier.

2. The device as claimed in claim 1 for labeling data carriers with a central opening, wherein the stencil has a mounting opening of a diameter made to match the diameter of the central opening on the data carrier in such a way that the stencil can be placed rotatably onto a mount penetrating through the central opening.

3. The device as claimed in claim 2, wherein the stencil is likewise formed as a circular disk, its outside diameter being at least approximately the same size or greater than that of the data carrier and the mounting opening being arranged in the center.

4. The device as claimed in claim 2, wherein the stencil has on its side facing the data carrier spacing elements, preferably in the form of an inner spacing ring, surrounding the mounting opening, and an outer spacing ring, surrounding the labels.

5. The device as claimed in claim 2, further comprising a carrier element with a mount penetrating through the central opening of the data carrier, it being possible for the data carrier to be connected in a rotationally secure manner to the carrier element at least when the stencil is in place.

6. The device as claimed in claim 1, further comprising a storage case with two wall portions arranged at a distance from each other and with mounting means for the rotatable mounting of the data carrier between the wall portions, and in that one of the wall portions contains the stencil.

7. The device as claimed in claim 6, wherein the storage case is formed as a cassette with a mounting base for receiving the data carrier and with a hinged cover and in that the stencil is arranged in the cover.

8. The device as claimed in claim 6, wherein the storage case is formed as an insert case with a lateral insertion opening for the data carrier and in that the stencil is arranged in a side wall of the insert case.

9. The device as claimed in claim 1, wherein the stencil is produced from a transparent or partly transparent material, preferably from a plastics material.

10. The device as claimed in claim 1, wherein the labels on the stencil are arranged on preferably a number of circular rings, which run concentrically in relation to the axis of rotation.

11. The device as claimed in claim 6, wherein at least one of the wall portions has an opening and/or a clearance for the manual turning of the data carrier.
